(19) United States
(12) Patent Application Publication
(10) Pub. No.: US 2005/0032677 A1
(43) Pub. Date: Feb. 10, 2005

(54) Fungicidal and/or bactericidal composition, production process thereof and sterilization method using the composition

(76) Inventors: Eiichi Kitakuni, Chiba (JP); Tadashi Yoneda, Chiba (JP); Toshi Tsuzuki, Chiba (JP); Eiji Ogata, Chiba (JP)

Correspondence Address: SUGHRUE MION, PLLC, 2100 PENNSYLVANIA AVENUE, N.W., SUITE 800, WASHINGTON, DC, 20037, US

(21) Appl. No.: 10/486,327

(22) PCT Filed: Aug. 9, 2002
(86) PCT No.: PCT/JP02/08181

Related U.S. Application Data
(60) Provisional application No. 60/316,266, filed on Sep. 4, 2001.

(30) Foreign Application Priority Data
Aug. 10, 2001 (JP) 2001-244089

(51) Int. Cl. A01N 63/00

(52) U.S. Cl. 514/9

(57) ABSTRACT

The present invention relates to a fungicidal and/or bactericidal composition comprising a combination of iturin and surfactin which are a cyclic peptide produced by a mircoorganism, preferably a microorganism belonging to the genus Bacillus, with an amphipathic organic material having a hydrocarbon chain, its production process and sterilization method using the same. The fungicidal and/or bactericidal composition of the present invention is highly safe to human body or environment, is free of generation of resistant bacteria even on repeated use and has a wide sterilization spectrum.

### CROSS REFERENCE TO THE RELATED APPLICATIONS

This is an application based on the prescription of 35 U.S.C. Section 111(a) with claiming the benefit of filing date of U.S. Provisional application Ser. No. 60/316,266 filed Sep. 4, 2001 under the provision of 35 U.S.C. 111(b), pursuant to 35 U.S.C. Section 119(e)(1).

### TECHNICAL FIELD OF THE INVENTION

The present invention relates to a fungicidal and/or bactericidal composition excellently safe and useful in various industrial fields. More specifically, the present invention relates to a fungicidal and/or bactericidal composition comprising a combination of iturin and surfactin which are a cyclic peptide produced by a microorganism, preferably a microorganism belonging to the genus Bacillus, with an amphipathic organic material having a hydrocarbon chain, its production process and sterilization method using the same.

### BACKGROUND ART

For the purpose of preventing various products from contamination by microorganisms, various compounds having fungicidal and/or bactericidal activity have been heretofore found or developed. Fungicidal and/or bactericidal compositions comprising these compounds individually or in combination are used, for example, for preventing food or building material from contamination by miscellaneous microorganisms and also for sterilizing and disinfecting hospital, sanitation such as cookery, or bathroom. Accordingly, the fungicidal and/or bactericidal composition is indispensable for daily life. However, these compounds generally have high toxicity in many cases and the amount used thereof is limited, therefore, sufficiently high fungicidal and/or bactericidal effect cannot be necessarily brought out at present.

Paraoxybenzoic acid esters which have heretofore been considered harmless to a human body and used for foods in many cases are recently doubted to be a so-called environmental hormone (endocrine disrupter). Thus, fungicidal and/or bactericidal compositions comprising a conventional compound cannot be always safe. In addition, a fundamental problem is not solved such that even if a compound such as paraoxybenzoic acid ester is added to foods, the microorganism as an objective of prevention immediately becomes resistant to the compound, as a result, the compound abruptly decreases in the fungicidal and/or bactericidal power and finally loses its efficacy.

Under these circumstances, iturin which is a constituent element of the present invention has been heretofore reported to have antibacterial and antibiotic activity. For example, R. Maget-Dana et al. (Toxicology, 87, 151-174 (1994)) presume that iturin interacts with cytoplasm membrane and forms a quaternary structure together with phospholipid or sterol in the cell membrane to form a through hole in the cell membrane, whereby the strong antibiotic activity of iturin to fungus is brought out. Also, C. Latoud et al. (Can. J. Microbiol, 36; 3849-389 (1990)) have reported that when the binding of iturin to a cell membrane is observed using a yeast (Saccharomyces cerevisiae) and a variant strain thereof, the binding depends on the alkyl chain length of sterol in the cell membrane.

M. A. Klichi et al. (Mycopathologia, 127: 123-127 (1994)) have measured the preventive and removal effect of iturin on the contamination by mold generated during storage of various grains in view of strong antibiotic activity of iturin on mold and high safety thereof to animals and reported that when iturin is used in a concentration of 50 to 100 ppm, the generation of mold can be extremely inhibited. L. Thinmon et al. (Biotechnology and Applied Biochemistry, 16; 144-151 (1992)) have found that the interaction of iturin with erythrocyte membrane is intensified in the presence of surfactin, and presume that a micelle produced by iturin and surfactin participates in this intensification.

R. Maget-Dana et al. (Biochimie, 74; 1047-1051 (1992)) have found that the hemolysis activity of iturin is increased by surfactin, and suggest that this increase is attributable to the interaction between iturin and surfactin. As such, many studies have been made on the antibiotic activity of iturin and it is considered that iturin can first bring out the antibiotic activity when interacted with a cell membrane. Furthermore, it is known that iturin is sometimes increased in the antibiotic activity by forming a complex with surfactin and allowing this complex to act on a cell membrane.

The method for applying the antibiotic activity of iturin to the prevention of growth of plant pathogenic fungi is disclosed in JP-A-59-212416 (the term “JP-A” as used herein means an “unexamined published Japanese patent application”), JP-A-61-289005 and JP-A-61-289898. However, the preventive effect is not sufficiently high in the practical level. Only JP-A-6-135811 discloses a method of elevating the antibiotic activity of iturin by using it in combination with surfactin and enhancing the performance of controlling the plant pathogenic fungi in the practical level.

On the other hand, with respect to the interacting activity of iturin with surfactin on a cell membrane ingredient, the hemolysis activity of erythrocyte has been heretofore mainly studied. As for the microorganism, studies are limited only to testing of a part of microorganisms such as yeast, and there has been no report on the method of giving a fungicidal and/or bactericidal effect on microorganisms over a wide range as disclosed in the present invention. As for the cell membrane, it is pointed out that the interaction with an organic ingredient in the cell membrane of microorganism as an objective of control by iturin is very important. However, a fungicidal and/or bactericidal composition and sterilization method has not been known yet which surely enables the fungicidal and/or bactericidal activity of iturin completely independent of the cell membrane ingredient, as in the fungicidal and/or bactericidal composition disclosed in the present invention, by previously introducing an amphipathic organic material having a hydrocarbon chain in addition to iturin and surfactin.

With respect to microorganisms of producing iturin and surfactin, for example, U.S. Pat. No. 6,103,228 discloses Bacillus subtilis AQ713 strain and a variant strain thereof. Bacillus subtilis SD901 strain (FERM P-17989) disclosed in the present invention produces only surfactin and therefore, this strain itself cannot be expected to have fungicidal and/or bactericidal control. SD142 strain which is a Bacillus subtilis strain disclosed in JP-A-06-135811 was found before the filing of AQ713 (NRRL B-21661) and is a completely different Bacillus subtilis strain from AQ713.

### DISCLOSURE OF THE INVENTION

The object of the present invention is to provide an excellent fungicidal and/or bactericidal composition which is highly safe to human body or environment, is free from generation of resistant bacteria even on repeated use and has a wide fungicidal and/or bactericidal spectrum.

Under these circumstances, the present inventors have made extensive investigations, as a result, to find that an excellent fungicidal and/or bactericidal effect is provided by changing the composition ratio of iturin, surfactin and an amphipathic organic material having a hydrocarbon chain. The present invention has been accomplished based on this finding.

More specifically, the present invention relates to the following matters.

1. A fungicidal and/or bactericidal composition comprising iturin, surfactin and an amphipathic organic material having a hydrocarbon chain.

2. The fungicidal and/or bactericidal composition as described in 1 above, wherein the composition ratio (by mol) of iturin to surfactin is from 10:1 to 1:10. 3. The fungicidal and/or bactericidal composition as described in 1 or 2 above, wherein the ratio by weight of the amphipathic organic material having a hydrocarbon chain to the mixture of iturin and surfactin is from 1 to 1,000 times.

4. The fungicidal and/or bactericidal composition as described in any one of 1 to 3 above, wherein the iturin is an iturin-base peptide represented by the following formula (1) 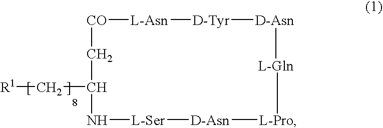
wherein n represents 0 or 1 and R¹ represents a straight or branched alkyl group having 3 to 6 carbon atoms.

5. The fungicidal and/or bactericidal composition as described in any one of 1 to 3 above, wherein the surfactin is a surfactin-base peptide represented by the following formula (2) 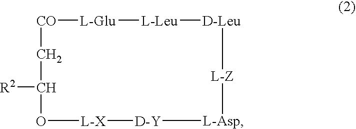
wherein X, Y and Z, which may be the same or different, each represents an amino acid selected from the group consisting of leucine, isoleucine, valine, glycine, serine, alanine, threonine, asparagine, glutamine, aspartic acid, glutamic acid, lysine, arginine, cysteine, methionine, phenylalanine, thyrosin, tryptophan, histidine, proline, 4-hydroxyproline and homoserine, and R² represents a straight or branched alkyl group having 8 to 14 carbon atoms.

6. The fungicidal and/or bactericidal composition as described in 1 or 3 above, wherein the amphipathic organic material having a hydrocarbon chain is one or more compound(s) selected from the group consisting of long chain fatty acids, glycerophospholipid, sphingolipid, glyceroglycolipid, sphingoglycolipid, acylglycerol, wax, cholesterol ester, ester compounds of vitamin A or D, compounds having a cyclopentanohydrophenanthrene ring, and these organic compounds having bound thereto a protein.

7. The fungicidal and/or bactericidal composition as described in 1 or 3 above, wherein the amphipathic organic material having a hydrocarbon chain is a compound constituting one or more cell membrane(s) selected from those of the group consisting of microorganism, erythrocyte, plant cell and virus each including an amphipathic organic material.

8. The fungicidal and/or bactericidal composition as described in 1 or 3 above, wherein the amphipathic organic material having a hydrocarbon chain is one or more member(s) selected from the group consisting of liposome, adjusted cell vesicle and virus envelope each including an amphipathic organic material.

9. The fungicidal and/or bactericidal composition as described in any one of 1 to 4 above, wherein the iturin is originated in a microorganism belonging to the genus Bacillus.

10. The fungicidal and/or bactericidal composition as described in any one of 1 to 3 or 5 above, wherein the surfactin is originated in a microorganism belonging to the genus Bacillus.

11. The fungicidal and/or bactericidal composition as described in 9 above, wherein the microorganism belonging to the genus Bacillus is Bacillus subtilis SD142 (FERM P-13204).

12. The fungicidal and/or bactericidal composition as described in 10 above, wherein the microorganism belonging to the genus Bacillus is Bacillus subtilis SD901 strain (FERM P-17989).

13. A sterilization method comprising forming a through hole structure in a cell membrane by the fungicidal and/or bactericidal composition described in any one of 1 to 12 above and thereby killing the cell.

14. The sterilization method as described in 13 above, wherein the through hole structure is formed by using microorganism cell, erythrocyte, plant cell, virus, cell vesicle or liposome each including an amphipathic organic material.

15. The sterilization method as described in 13 or 14 above, wherein the fungicidal and/or bactericidal composition is pretreated before forming the through hole structure.

16. The sterilization method as described in any one of 13 to 15 above, wherein the objective of sterilization is bacteria and fungi.

17. A process for producing a fungicidal and/or bactericidal composition, comprising mixing surfactin obtained using Bacillus subtilis SD901 (FERM P-17989), iturin and an amphipathic organic material having a hydrocarbon chain.

18. The process for producing a fungicidal and/or bactericidal composition, comprising mixing iturin obtained using Bacillus subtilis SD142 (FERM P-13204), surfactin and an amphipathic organic material having a hydrocarbon chain.

Mode for Carrying Out the Invention

In the present invention, the term “sterilization” widely includes prevention, killing, control, removal and the like of microorganisms.

From the results in studies so far, the present inventors have noticed the fact that iturin can be judged effective on growth inhibition and sterilization of mold fungi such as mold but on the other hand, the effect is not so high on bacteria such as Micrococcus and Sarcina. In this regard, R. Maget-Dana et al. (Toxicology, 87; 151-174 (1994)) suggest that a sterol present in the cell membrane such as cholesterol influences the exertion of the effect.

Similarly, L. C. Peypoux et al. (Can. J. Microbiol, 36; 384-389 (1990)) examined the binding ability of iturin to yeast (Saccharomyces cerevisiae) cell and have reported that the binding ability of iturin to yeast cell membrane is determined by a sterol and that cholesterol is higher in the affinity for iturin than ergosterol but, on the contrary, lower in the affinity for stigmasterol.

L. Thimon et al. (Cytobios, 79; 69-83 (1994)) examined the activity of iturin to inhibit the growth of yeast cell (Saccharomyces cerevisiae) and the physiological activity on erythrocyte membrane and have reported that the physiological activity of iturin on the cell membrane is elevated by surfactin. Also, R. Maget-Dana (Riochimie, 74; 1047-1051 (1992)) has reported that hemolysis activity of iturin is elevated by surfactin and in the report, it is observed that as the addition of iturin to the monomolecular film of surfactin proceeds, the surface tension of the film increases. From these, it is presumed that iturin peculiarly interacts with surfactin and penetrates into the film while forming a micelle. Also, this micelle formation is revealed to occur only when an acidic amino acid of surfactin is dissociated (pH 5.0 or higher). On the other hand, L. Thimon et al. (Cytobios, 79; 69-83 (1994)) state that mineral ion takes an important role in the micelle formation between iturin and surfactin.

Based on the above-described knowledge, the present inventors have made extensive investigations on the micelle formation between iturin and surfactin, as a result, to find that at the micelle formation with surfactin, D-Tyr of iturin is exposed to the aqueous solution side and similarly, the acidic amino acid L-Glu of surfactin is also exposed to the aqueous solution side. Surfactin originally has high surface activity and undertakes association in an aqueous solution to form a micelle. The critical micelle concentration (CMC) of surfactin is determined as 250 μM by L. Thimon et al. (Biotechnology and Applied Biochemistry, 16; 144-151 (1992)).

In the equivalent mixing of iturin and surfactin, the CMC is decreased to 130 μM and this decrease of CMC means that the dissociation group of acidic amino acid L-Asp or L-Glu of surfactin is neutralized accompanying the micelle formation with iturin. In other words, either one of the polar groups is selectively neutralized and therefore, the CMC which is 250 μM in the case of surfactin alone is halved to 130 μM. This knowledge is completely coincident with the above-described observation results.

Furthermore, L. Thimon et al. (Biotechnology and Applied Biochemistry, 16; 144-151 (1992)) presume that since both the CMC in the case of surfactin alone and the CMC in the mixed micelle of iturin and surfactin greatly decrease to 10 μM in a 0.1M sodium hydrogencarbonate solution, the acidic amino acid in the dissociated state is neutralized by sodium ion and this inhibits the formation of micelle. At the same time, this result suggests that the hydrophobic interaction is a driving force of the micelle formation and that the presence of a cation is not preferred for attaining good association of amphipathic lipoprotein having a peculiar cyclic structure, such as iturin or surfactin, to form micelles and that a colloid is disorderly formed by the presence of a cation.

With respect to the relationship between the mixing ratio of iturin and surfactin and the formation of micelle structure, L. Thimon et al. (Biotechnology and Applied Biochemistry, 16; 144-151 (1992)) examined the binding ability of iturin and surfactin to an erythrocyte membrane using C¹⁴ labeled iturin and surfactin and observed that when the mixing ratio of iturin to surfactin was 1:2 or 2:1, the amount of the latter bound to erythrocyte membrane was about 7 times larger than that of the former, however, the hemolysis activity which was observed at the same time was almost the same.

In the case of using iturin alone, the amount bound to the erythrocyte membrane was at most about a half of that when mixing iturin and surfactin in the latter ratio and the hemolysis activity was also about one sixth. From these results, it is revealed that at least the hemolysis activity of iturin is increased by surfactin irrespective of the amount of iturin or a mixed micelle bound to erythrocyte membrane while the binding of iturin to erythrocyte membrane may be reinforced by surfactin. The present inventors produced a mixed micelle of iturin and surfactin by changing the mixing ratio with the CMC of iturin of 40 μM or less, however, as described later, if surfactin is excess as compared with iturin, free surfactin increases and the presence ratio of a mixed micelle decreases.

The present inventors have confirmed that the destruction of cell membrane by iturin is attributable to a peculiar structure formed by iturin and a certain kind of organic compound, particularly an amphipathic organic compound containing a hydrocarbon chain (for example, a hydrocarbon chain having 29 or more carbon atoms), which has high affinity for a cell membrane, and that this structure associates with each other by the hydrophobic interaction to provide a through hole in the membrane. The present inventors presumed that the increasing activity by the surfactin is also attributable to the increase of the through holes, and further continued studying.

The above-described observation by L. Thimon et al. reveals that the cell membrane destroying activity of iturin is reinforced by surfactin irrespective of the amount bound to the cell membrane. On the other hand, the present inventors have confirmed that when iturin and surfactin are mixed by changing the mixing ratio, the CMC of the solution system lowers as the addition of iturin to surfactin proceeds. However, when excess surfactin is present as compared with iturin, sufficient mixed micelles cannot be formed because the CMC of surfactin controls the micelle formation of the aqueous solution system.

In this state, when iturin is further added, the formation of a mixed micelle is accelerated. It has been found that when iturin is present in a molar ratio to surfactin of 0.1 to 10 times, preferably from 0.4 to 3 times, mixed micelles are most successfully formed. On the other hand, the activity of destroying a cell membrane is governed by the interaction between iturin and cell membrane and it has been confirmed that with CMC or less, a fairly large amount of free surfactin migrates to the surface of cell membrane, thereby stabilizing the solution system, and iturin is also adsorbed to the cell surface accompanying this migration. From this, it has been confirmed that even if a mixed micelle is not formed, the activity of iturin on a cell membrane is aided by the presence of surfactin.

With respect to the through hole formed in the cell membrane by iturin, from the above-described knowledge, it is difficult to consider that the mixed micelle of iturin and surfactin necessarily develops to a through hole in view of structure and it is presumed that the interaction with an amphipathic substance or with a hydrophobic substance constituting the cell membrane probably plays an important role in the formation of through hole structure.

For example, R. Maget-Dana et al. (Toxicology, 87; 151-174 (1994)) electrically observed the formation of through hole in a membrane system by iturin, using an artificial monomolecular film. According to the observation, it is presumed that an amphipathic lipoprotein such as iturin penetrates into a cell membrane and forms an aggregate with a phospholipid inside, the membrane on the way of penetration, as a result, providing a through hole. In particular, since iturin forms a strong complex with a sterol such as cholesterol, sterols are considered to participate in the formation of a through hole.

L. C. Peypoux et al. (Can. J. Microbiol, 36; 384-389 (1990)) measured the dissociation constant of iturin and three kinds of sterols (ergosterol, cholesterol and stigmasterol), using a cell membrane of yeast (Saccharomyces cerevisiae) and revealed that approximately from 5.0×10⁹ to 6.0×10⁹ pieces of iturin at the maximum per yeast cell are bound to the cell membrane and the number bound varies depending on the alkyl chain length of sterol, for example, the number bound to stigmasterol is only about a half of that to cholesterol. It was also revealed that with CMC of iturin of 40 μM or less, the binding between iturin and cell membrane weakens and in turn, the antibiotic activity of iturin decreases.

On the other hand, the experiment made by L. Thimon et al. (Biotechnology and Applied Biochemistry, 16; 144-151 (1992)) revealed that when iturin in 20 μM which is lower than the CMC of iturin is allowed to act on an yeast, the formation of mixed micelle is accelerated by the addition of surfactin as described above and therefore, the antibiotic activity of iturin increases.

The present inventors have noticed the fact that the exertion of antibiotic activity of iturin is governed by two factors, namely, the access and penetration of iturin to cell membrane and subsequent formation of a composite with the cell membrane ingredient, and the micelle formation in a solution. The main object of the present invention is to use iturin in its CMC or less and at the same time to bring out strong fungicidal and/or bactericidal activity. In order to accomplish these conflicting phenomena, the present inventors aimed at developing an effective fungicidal and/or bactericidal composition by combining iturin, surfactin and an amphipathic organic compound ingredient having a hydrocarbon chain, which is considered to have high affinity for cell membrane.

For allowing iturin in its CMC or less to form a through hole in a target cell, a method by a mixed micelle was considered most effective and studies have been made on the formation of a mixed micelle formed by iturin and surfactin and the activity of the mixed micelle on a cell membrane. The present inventors were interested in the point that the CMC of iturin is 130 μM in the case of equivalent mixing of iturin and surfactin, whereas in the presence of cation in a high concentration, the CMC decreases to 10 μM irrespective of iturin and surfactin, colloid is disorderly formed and coagulation immediately takes place.

For example, the present inventors formed colloid in each 0.1M sodium hydrogencarbonate solution of iturin, surfactin and a mixture of both, preincubated each colloid together with a yeast (Saccharomyces cerevisiae) and an artificially synthesized liposome under the conditions of room temperature (25° C.) for about 10 to 60 minutes, and measured the change in volume of yeast cell or liposome vesicle using the stopped flow-light scattering method by rapidly mixing an equivalent amount of 0.25M magnesium chloride solution, 0.25M calcium chloride solution, 0.5M sodium chloride solution, 1.0M glucose solution or the like in a reaction cell and by observing the scattered light in the direction of 90°.

When a cell or a liposome envelope is mixed with a hypertonic solution, the cell or liposome envelope is abruptly crushed due to difference in the osmotic pressure between inside and outside of the membrane and the intensity of scattered light increases. Subsequently, in the case where the membrane has a through hole, the difference in osmotic pressure is eliminated through the through hole and therefore, the intensity of scattered light gradually recovers to its base level. In this case the time required for the recovery to the base level can be a standard for the passing of a molecule through the through hole.

By this study, it was found that the colloid of surfactin alone is strong in the association power and exhibits weak permeability into the membrane even if coming close to a target membrane, while the colloid of iturin or the colloid of iturin and surfactin is weak in the hydrophobic cohesion as compared with the colloid of surfactin alone and readily interacts with the membrane to form a through hole.

It was also found that the size of the through hole is sufficiently large to pass a divalent cation and depending on the mixing conditions with the membrane, even a neutral glucose molecule can be passed. Furthermore, it was found that since the permeability of liposome is varied by changing its composition, the structure of through hole can be controlled by the composition of liposome, that is, the organic compound having high affinity for membrane.

Therefore, the present inventors further continued extensive investigations by changing the composition of liposome. With respect to lipid as a constituent ingredient of cell membrane, for example, in the case of erythrocyte membrane, nearly 90% of the lipid is occupied by sphingolipid such as cholesterol and sphingomyelin and glycerophospholipid. Sterols other than cholesterol include, depending on the length of alkyl chain, stigmasterol, P-sitosterol and ergosterol, and these sterols not only participate in the function such as control of the hardness of membrane or the permeation through the membrane but also exert the physiological activity by binding to a lipoprotein. The lipoprotein is literally a composite of lipid and protein and has a role of carrying a lipid and dispersing it in the body of an organism by the interaction with protein.

By taking notice of an amphipathic organic material considered to have high affinity for a membrane such as long chain fatty acids (stearic acid, palmitic acid, myristic acid, linoleic acid, linolenic acid, etc.), glycerophospholipid, sphingolipid, glyceroglycolipid, sphingoglycolipid or acylglycerol (esters of fatty acids with various alcohols), wax, cholesterol ester, ester compounds of vitamin A or D, compounds having a cyclopentanohydrophenanthrene ring, and these organic compounds having bound thereto a protein, these compounds were included in an artificial liposome membrane prepared from lecithin (phosphatidylcholine) and then, iturin and surfactin were allowed to act on this membrane to examine the formation of a through hole structure.

As a result, it was found that the compound forms a composite with iturin penetrated into the membrane or with a mixed micelle of iturin and surfactin and thereby, forms a through hole structure within the membrane. Particularly, in the case of allowing a mixed micelle of iturin and surfactin to act, it was found that a sufficiently large through hole can be provided even with a concentration as low as a half or less of the concentration in case of allowing iturin alone to act. The through hole structure provided in the membrane was a composite structure by iturin, surfactin and the amphipathic organic material and depending on the length of hydrocarbon chain, the diameter of the through hole was sufficiently large to pass a divalent cation.

The present inventors examined the formation of a through hole by pretreating 5 to 20 μM iturin, 5 to 60 μM surfactin and 5 to 200 μM cholesterol or 5 to 200 μM lipoprotein having a cholesterol skeleton before allowing these to act on an artificial liposome membrane. As a result, it was surprisingly found that the through hole is formed at a higher rate as compared with the control not passed through a pretreatment and the density of the through hole reaches approximately twice or more depending on the mixing conditions. This reveals that it is effective not only to pass a process where iturin penetrates into a membrane, spontaneously associates with an amphipathic organic material affined to the membrane and forms a through hole structure, but also to form a pre-structure to make it penetrate into the membrane. Thus, it was found that by performing a pretreatment, a satisfactory through hole can be formed, for example, even in Micrococcus or Sarcina where the effect of iturin had been heretofore not observed.

The present inventors have also confirmed that the penetration of through hole structure into a cell membrane is improved by this pretreatment. This reveals that the through hole structure by iturin is also allowed to act on a target cell by the fusion (membrane fusion) of the cell, for example, when using Sendai virus or an artificial liposome including an organic compound having a long chain hydrocarbon in place of the organic compound.

With respect to the method concerning such cell membrane fusion, for example, U.S. Pat. No. 5,663,580 discloses a method of using a lipid vesicle for transporting a bioactive substance to a cell. According to this method, a lipid vesicle can be used as means to transport a substance having affinity for a lipid membrane to a target cell. According to the present invention, by previously forming in a virus envelope or a liposome membrane a through hole structure composite by iturin, surfactin and an amphipathic organic material having a hydrocarbon chain the structure as it is can be easily transferred to a target cell by fusion.

As for this fusion, the present inventors have also found that the membrane fusion is accelerated by the surface active activity of surfactin. In this meaning, the present invention has been accomplished based on a conventionally unknown knowledge that the cell destroying activity of iturin is elevated using two functions of surfactin, that is, formation of a mixed micelle with iturin and acceleration of fusion with a cell membrane.

Based on this new finding, the present invention relates to a method of previously mixing iturin, surfactin and an organic compound containing a hydrocarbon chain having high affinity for a cell membrane, allowing the mixture to act on a target microorganism to form a through hole in the cell membrane of the microorganism, and thereby killing the microorganism.

The present invention also provides a fungicidal and/or bactericidal composition satisfying the absolute required amounts of iturin, surfactin and an amphipathic organic material which are main effective ingredients for sterilization.

More specifically, iturin and surfactin are mixed at a molar partial ratio of 10:1 to 1:10, preferably from 3:1 to 1:3, and thereto, one or more amphipathic organic material(s) selected from the group consisting of long chain fatty acids (stearic acid, palmitic acid, myristic acid, linoleic acid, linolenic acid, etc.), glycerophospholipid, sphingolipid, glyceroglycolipid, sphingoglycolipid or acylglycerol (esters of fatty acids with various alcohols), wax, cholesterol ester, ester compounds of vitamin A or D, compounds having a cyclopentanohydrophenanthrene ring, and these organic compounds having bound thereto a protein is added, for example, in an amount of 1 to 1,000 times, preferably from 1 to 50 times, in terms of the weight ratio to the mixture, whereby a desired fungicidal and/or bactericidal composition can be obtained.

The contents of iturin and surfactin absolutely come short when iturin and surfactin are only supplied by the simple culturing and the fungicidal and/or bactericidal effect cannot be brought out. In order to satisfy the bactericidal effect of the present invention, it is essential to condensate or purify the culture solution. Or condensed or purified iturin and surfactin may be supplemented.

With respect to the fungicidal and/or bactericidal composition containing iturin disclosed in the present invention, for example, JP-A-7-143897 discloses in Example 1 the production of iturin by the Bacillus amyloliquefaciens strain, where the total yield of iturin is about 600 mg per 15 L of the culture solution of the Bacillus strain and in this case, the amount of iturin accumulated is only 40 ppm per the culture solution. Furthermore, JP-A-2-209803 and JP-A-5-51305 describe Bacillus subtilis strains which can produce iturin, however, presuming from the control effect by these Bacillus strains provided in Examples, it is considered that the production of iturin is in the same level as in JP-A-7-143897.

As such, the genus Bacillus strain is well known as a microorganism which can produce iturin. Among these, Bacillus amyloliquefaciens and Bacillus subtilis are famous. Similarly, as described in U.S. Pat. No. 5,958,728, the genus Bacillus strain is known to produce surfactin. On the other hand, for use as the fungicidal and/or bactericidal composition of the present invention, a genus Bacillus strain capable of accumulating iturin in the culture solution in an amount of at least 1,000 ppm, preferably 10,000 ppm or more, per culture solution is preferred, however, such a strain of the genus Bacillus is not known.

The fungicidal and/or bactericidal composition of the present invention is produced by mixing iturin, surfactin and an amphipathic organic material having a hydrocarbon chain.

As for the production method therefor, a microorganism capable of high production of iturin and a microorganism capable of high production of surfactin can be used in place of iturin and surfactin.

The fungicidal and/or bactericidal composition obtained by the present invention has an effect over a wide range, for example, on bacteria and fungi.

### BRIEF DESCRIPTION OF DRAWINGS

FIG. 1 shows the volume change of liposome vesicle when the bactericidal composition of the present invention (iturin+surfactin+cholesterol) is allowed to act on a liposome prepared from soybean lecithin and the membrane permeability by the through hole formed in the liposome is measured using the stopped flow-light scattering method, compared with the volume change of a liposome alone.

### BEST MODE FOR CARRYING OUT THE INVENTION

The present invention is described in greater detail below by referring to Examples, however, the present invention should not be construed as being limited to these Examples.

### EXAMPLE 1

200 mL of a seed culture medium having a culture medium composition of 2% glucose, 0.5% peptone, 0.1% yeast extract, 0.01% CaCl₂, 0.01% NaCl and 0.5% KH₂PO₄ was adjusted to a pH of 7.0, sterilized at 120° C. for 20 minutes using an autoclave and cooled. In this culture medium, Bacillus subtilis SD142 strains (FERM P-13204) previously pre-cultured in an agar medium (L culture medium) was inoculated using a loop and cultured under shaking at 30° C. for 10 hours.

Subsequently, 20 L of a production culture medium comprising 2% soybean powder, 7% maltose, 20 ppm MgSO₄, 20 ppm FeSO₄, 20 ppm MnSO₄, 200 ppm CaCl₂ and 0.5% KH₂PO₄ was prepared in a 30 L-volume jar fermenter, sterilized at 120° C. for 15 minutes and cooled. In this culture medium, 200 mL of the seed culture medium prepared above was inoculated and cultured at 30° C., an aeration amount of 0.5 vvm and a stirring number of 200 rpm for 96 hours.

After the completion of culture, 20 L of culture solution was centrifuged (6,000 rpm×30 min) to sediment the cells, and the supernatant was recovered. To this supernatant, an equivalent amount of 2N nitric acid was added to cause precipitation and the precipitate was further-sedimented by centrifugation (6,000 rpm×20 min). The precipitate contained iturin and surfactin produced by the strain. To this precipitate, 2 L of methanol was added and after dissolving the precipitate while thoroughly stirring, the methanol solution was further centrifuged (6,000 rpm×20 min). The precipitate was removed and the supernatant methanol solution was adsorbed by passing it through a column packed with ODS-C18 (produced by Showa Denko K.K.). After washing the column with 5 L of 20% acetonitrile, iturin and surfactin were eluted with 50% acetonitrile.

The eluate was condensed under reduced pressure by evaporation and the solvent was distilled off to obtain iturin and surfactin. The mixture obtained was again dissolved in 50% acetonitrile and through Shodex (registered trademark of Showa Denko K.K.) C18P-4E (produced by Showa Denko K.K.), iturin and surfactin were eluted using as an eluent 45% acetonitrile/water/10 mM ammonium acetate for iturin and 51% acetonitrile/0.2% trifluoroacetate (TFA)/water for surfactin, thereby separating the peaks. At this time, marker products (ITURIN A and SURFACTIN) produced by Sigma Co., Ltd. were used as the standard and the yield of each microorganism was determined from the peak area ratio.

As a result, the yields of the obtained iturin and surfactin were 3.1 g and 3.5 g, respectively. Thus, about 6.6 g of mixture was obtained wherein the ratio of iturin and surfactin was nearly 1:1.

### EXAMPLE 2

A potato dextrose (PDA) plate agar culture medium (plate) containing 10 ppm of the iturin and surfactin mixture obtained in Example 1, a PDA agar culture medium obtained by further adding 50 ppm of cholesterol to the mixture, and a normal PDA agar culture not containing these were prepared. In each of these agar culture mediums, a target microorganism previously mixed with a sterilized water was inoculated by coating and cultured at 25° C. for 5 days in a dark place. Thereafter, the area where the microorganism had grown was measured and the ratio (%) occupying in the entire area was determined and used as an index for growth inhibitory power.

The results obtained are shown in Table 1. The mixture of iturin and surfactin was verified to exert very high growth inhibitory effect on mold fungi. When cholesterol was further added, the growth inhibitory effect was brought out on all microorganisms tested.

TABLE 1

| | | +Iturin & | |
|---|---|---|---|
| | PDA | Surfactin | +Cholesterol |
| Aspergillus niger | 100 | 65 | 45 |
| Fusarium moniliforme | 100 | 30 | 20 |
| Fusarium oxysporum | 100 | 28 | 21 |
| Botrytis cineraea | 98 | 18 | 14 |
| Penicillium oxalicum | 100 | 22 | 19 |
| Alternaria mali | 95 | 34 | 21 |
| Phytophthora infestans | 100 | 23 | 18 |
| Trichoderma reesei | 100 | 19 | 8 |
| Mucorales | 100 | 45 | 38 |
| Micrococcus halobius | 97 | 69 | 50 |
| Xanthomonas oryzae | 96 | 89 | 80 |

+Iturin & Surfactin: PDA culture medium containing 10 ppm of the iturin and surfactin mixture
+Cholesterol: PDA culture obtained by adding 50 ppm of cholesterol to the above

### EXAMPLE 3

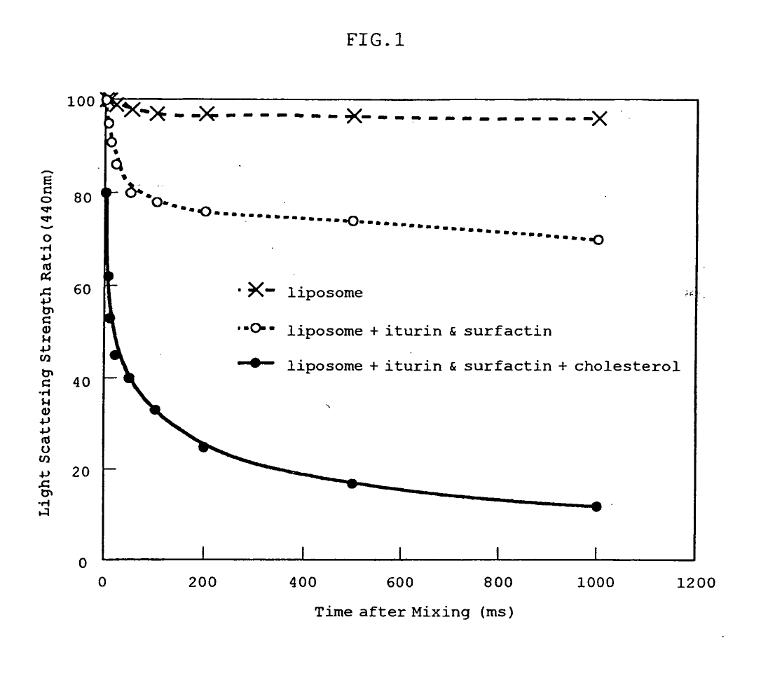

The iturin and surfactin mixture obtained in Example 1 was allowed to act on a liposome separately prepared from a lecithin of soybean (phosphatidylcholine) and the membrane permeability of the through hole formed in the liposome was measured by the stopped flow-light scattering method. 100 mL of a 2.0 g/L reconstructed liposome solution and 35 ppm of the iturin and surfactin mixture were previously incubated at room temperature (25° C.) for 30 minutes. This liposome solution and a 0.5M potassium chloride solution were momentarily mixed each in an equivalent amount (300 μL) using a nitrogen gas and the light scattering strength in the direction of 90° was measured at 440 nm. The measurement was carried out in the same manner with a sample obtained by adding 100 ppm of cholesterol to the above-described liposome solution. The results are shown in FIG. 1.

It is seen from FIG. 1 that the recovery of light scattering strength, that is, the volume recovery of liposome vesicle is completed faster in the presence of cholesterol as compared with the case of allowing iturin and surfactin alone to act on the liposome. This reveals that a through hole structure cannot be sufficiently formed in a liposome membrane only by iturin and surfactin, and the cholesterol plays an important role in the formation of a through hole structure.

Furthermore, a solution obtained by premixing iturin, surfactin and cholesterol each in the same concentration as above and a solution obtained by premixing liposome and a 0.5M potassium chloride solution were mixed in the same manner as in the test above, and the light scattering strength was measured. As a result, the volume recovery of liposome vesicle was confirmed to be equal to or slightly faster than that when cholesterol was added as shown in the scattering strength change in FIG. 1. This seems to suggest that a through hole structure or a precursor thereof is previously formed by iturin, surfactin and cholesterol.

### EXAMPLE 4

At the reconstruction of liposome, iturin, surfactin and cholesterol were previously mixed with the solution in the same manner as in Example 3. At this time, 20 ppm of the iturin and surfactin mixture obtained in Example 1 and 50 ppm of cholesterol were added to a liposome solution having a concentration of 2 g/L. The thus-reconstructed liposome A and the solution comprising liposome and a 0.5M potassium chloride solution prepared in Example 3 were mixed in the same manner as in Example 3 using a stopped flow-light scattering apparatus and the volume change was observed.

At this time, 20 ppm of a surfactant TRITON X-100 was previously added to the liposome solution containing iturin, whereby liposome could associate with each other and membranes could be bound. As a result, the volume recovery of liposome vesicle due to the formation of through holes in the membrane was observed similarly to Example 3.

It is suggested from this that when a through hole structure or a precursor thereof is previously formed in an artificial liposome membrane and it is allowed to act on a liposome envelope or a cell membrane, the structure can be easily transferred.

### EXAMPLE 5

Using the liposome solution including iturin, surfactin and cholesterol obtained in Example 4 and a normal liposome solution not containing these, the effect of inhibiting growth of microorganism on PDA culture medium was observed in the same manner as in Example 2. 100 μL of a liposome solution (2 g/L) containing 70 ppm of surfactin was added/coated to PDA plate and then, a microorganism was inoculated according to Example 2. The results obtained are shown in Table 2.

TABLE 2

| | PDA | Liposome N | Liposome S |
|---|---|---|---|
| Aspergillus niger | 100 | 93 | 45 |
| Fusarium moniliforme | 100 | 100 | 27 |
| Botrytis cineraea | 98 | 94 | 25 |
| Penicillium oxalicum | 100 | 100 | 75 |
| Trichoderma reesei | 100 | 97 | 43 |
| Mucorales | 100 | 91 | 29 |
| Sarcina constellatus | 99 | 75 | 70 |

Liposome N: normal liposome (containing 70 ppm of surfactin)
Liposome S: liposome containing 10 ppm of the iturin and surfactin mixture (in addition, containing 70 ppm of surfactin)

It is considered from these results that the liposome containing iturin and cholesterol is fused with the cell of microorganism inoculated and the through hole structure is transferred to the cell membrane, as a result, the growth inhibitory effect is exerted.

### EXAMPLE 6

The iturin and surfactin mixture obtained in Example 2 and the surfactin purified from a culture solution of Bacillus subtilis SD901 strain (FERM P-17989) were tested on the biodegradability according to the revised OECD 301C method (MITI method) as in below, i.e., by charging in a 300 ml sealed container a 100 ml test solution comprising standard activated sludge (SS (Suspended Solids) concentration: 100 ppm) with a 30 ppm material to be tested, stirring the test solution for 28 days at 30° C. in aeration and measuring the amount of consumed oxygen in the container to determine the biodegradability. From a control without the material to be tested and a positive control using aniline, it is judged to be easily degradable if the rate of degradation of the test solution is 60% or higher when that of aniline is 60% or higher.

As a result of the above test, both were found to have biodegradability of 60% or more. LD₅₀ of iturin examined by the hypodermic injection to a mouse was 157 mg/kg (J. Berdy, CRC press 4(1); 380 (1980)), which indicates that surfactin was low irritating to skin.

### INDUSTRIAL APPLICABILITY

In the fungicidal and/or bactericidal composition of the present invention, iturin, surfactin and an amphipathic organic material having a hydrocarbon chain are added, whereby the fungicidal and/or bactericidal activity of iturin can be remarkably elevated, a through hole can be formed in a cell membrane common to almost all microorganisms to kill the cell, and a wide sterilization spectrum can be provided. Furthermore, since iturin and surfactin have high biodegradability and excellent safety and a resistant bacterium is not produced, the bactericidal composition of the present invention can be used safely, is effective for the prevention and removal of harmful microorganisms over a wide range, and is effective in a wide variety of fields such as sterilization of bacteria or fungi.

1. A fungicidal and or bactericidal composition comprising iturin, surfactin and an amphipathic organic material having a hydrocarbon chain.

2. The fungicidal and/or bactericidal composition as claimed in claim 1, wherein the composition ratio (by mol) of iturin to surfactin is from 10:1 to 1:10.

3. The fungicidal and/or bactericidal composition as claimed in claim 1 or 2, wherein the ratio by weight of the amphipathic organic material having a hydrocarbon chain to the mixture of iturin and surfactin is from 1 to 1,000 times.

4. The fungicidal and/or bactericidal composition as claimed in any of claims 1 to 3, wherein the iturin is an iturin-base peptide represented by the following formula (1) 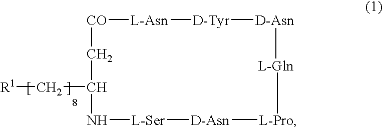
wherein n represents 0 or 1 and R¹ represents a straight or branched alkyl group having 3 to 6 carbon atoms.

5. The fungicidal and/or bactericidal composition as described in any one of claims 1 to 3, wherein the surfactin is a surfactin-base peptide represented by the following formula (2) 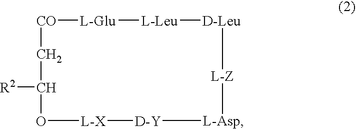
wherein X, Y and Z, which may be the same or different, each represents an amino acid selected from the group consisting of leucine, isoleucine, valine, glycine, serine, alanine, threonine, asparagine, glutamine, aspartic acid, glutamic acid, lysine, arginine, cysteine, methionine, phenylalanine, thyrosin, tryptophan, histidine, proline, 4-hydroxyproline and homoserine, and R² represents a straight or branched alkyl group having 8 to 14 carbon atoms.

6. The fungicidal and/or bactericidal composition as claimed in claim 1 or 3, wherein the amphipathic organic material having a hydrocarbon chain is one or more compound(s) selected from the group consisting of long chain fatty acids, glycerophospholipid, sphingolipid, glyceroglycolipid, sphingoglycolipid, acylglycerol, wax, cholesterol ester, ester compounds of vitamin A or D, compounds having a cyclopentanohydrophenanthrene ring, and these organic compounds having bound thereto a protein.

7. The fungicidal and/or bactericidal composition as claimed in claim 1 or 3, wherein the amphipathic organic material having a hydrocarbon chain is a compound constituting one or more cell membrane(s) selected from those of the group consisting of microorganism, erythrocyte, plant cell and virus each including an amphipathic organic material.

8. The fungicidal and/or bactericidal composition as claimed in claim 1 or 3, wherein the amphipathic organic material having a hydrocarbon chain is one or more member(s) selected from the group consisting of liposome, adjusted cell vesicle and virus envelope each including an amphipathic organic material.

9. The fungicidal and/or bactericidal composition as claimed in any one of claims 1 to 4, wherein the iturin is originated in a microorganism belonging to the genus Bacillus.

10. The fungicidal and/or bactericidal composition as claimed in any one of claims 1 to 3 or 5, wherein the surfactin is originated in a microorganism belonging to the genus Bacillus.

11. The fungicidal and/or bactericidal composition as claimed in claim 9, wherein the microorganism belonging to the genus Bacillus is Bacillus subtilis SD142 (FERM P-13204).

12. The fungicidal and/or bactericidal composition as claimed in claim 10, wherein the microorganism belonging to the genus Bacillus is Bacillus subtilis SD901 strain (FERM P-17989).

13. A sterilization method comprising forming a through hole structure in a cell membrane by the fungicidal and/or bactericidal composition as claimed in any one of claims 1 to 12 and thereby killing the cell.

14. The sterilization method as claimed in claim 13, wherein the through hole structure is formed by using microorganism cell, erythrocyte, plant cell, virus, cell vesicle or liposome each including an amphipathic organic material.

15. The sterilization method as claimed in claim 13 or 14, wherein the fungicidal and/or bactericidal composition is pretreated before forming the through hole structure.

16. The sterilization method as claimed in any one of claims 13 to 15, wherein the objective of sterilization is bacteria and fungi.

17. A process for producing a fungicidal and/or bactericidal composition, comprising mixing surfactin obtained using Bacillus subtilis SD901 (FERM P-17989), iturin and an amphipathic organic material having a hydrocarbon chain.

18. The process for producing a fungicidal and/or bactericidal composition, comprising mixing iturin obtained using Bacillus subtilis SD142 (FERM P-13204), surfactin and an amphipathic organic material having a hydrocarbon chain.
